(19) United States
(12) Patent Application Publication
(10) Pub. No.: US 2021/0357166 A1
(43) Pub. Date: Nov. 18, 2021

(54) AGENT CONTROL DEVICE, AGENT CONTROL METHOD, AND RECORDING MEDIUM

(71) Applicant: TOYOTA JIDOSHA KABUSHIKI KAISHA, Toyota-shi (JP)

(72) Inventor: Kohki TAKESHITA, Tokyo (JP)

(73) Assignee: TOYOTA JIDOSHA KABUSHIKI KAISHA, Toyota-shi (JP)

(21) Appl. No.: 17/244,439

(22) Filed: Apr. 29, 2021

(30) Foreign Application Priority Data
May 18, 2020 (JP) 2020-086647

(51) Int. Cl. G06F 3/14

(52) U.S. Cl. CPC G06F 3/14; H04W 76/14

(57) ABSTRACT

An agent control device that presents, on a display device, a display screen showing procedure information to set up and establish communication between a mobile terminal and an onboard device; and in a case in which information to reject establishment of communication between the mobile terminal and the onboard device has been input, or in a case in which input of a procedure has not been received after a predetermined time period has elapsed since presentation of the display screen on the display device, outputs to the display device a display screen recommending activation of a specific agent from among a plurality of agents that are utilizable inside a vehicle.

### CROSS-REFERENCE TO RELATED APPLICATION

This application is based on and claims priority under 35 USC 119 from Japanese Patent Application No. 2020-086647 filed on May 18, 2020, the disclosure of which is incorporated by reference herein.

### BACKGROUND

### Technical Field

The present disclosure relates to an agent control device, an agent control method, and a recording medium.

### Related Art

Japanese Patent Application Laid-Open (JP-A) No. 2018-189984 discloses a speech interaction method for utilizing services provided by two agents in which agent information such as a keyword used to identify an agent is employed to decide which out of the two agents should respond.

In cases in which an agent operated by a mobile terminal regularly used by a user is present, the user may wish to utilize the agent of the mobile terminal even when on board a vehicle.

However, the technology of JP-A No. 2018-189984 does not give consideration to selecting one agent from out of plural agents including an agent operated by a mobile terminal when inside a vehicle. There is accordingly room for improvement with regard to smooth selection from out of plural agents including an agent operated by a mobile terminal.

### SUMMARY

An aspect of the disclosure is an agent control device that includes: a memory; and a processor coupled to the memory. The processor is configured to present, on a display device, a display screen showing procedure information to set up and establish communication between a mobile terminal and an onboard device, and in a case in which information to reject establishment of communication between the mobile terminal and the onboard device has been input, or in a case in which input of a procedure has not been received after a predetermined time period has elapsed since presentation of the display screen on the display device, output to the display device a display screen recommending activation of a specific agent from among a plurality of agents that are utilizable inside a vehicle.

### BRIEF DESCRIPTION OF DRAWINGS

Exemplary embodiments of the present disclosure will be described in detail based on the following figures, wherein:

FIG. 1 is an explanatory diagram to provide schematic explanation of an exemplary embodiment;

FIG. 2 is a schematic block diagram illustrating an example of an agent control system according to an exemplary embodiment;

FIG. 3 is a diagram illustrating an example of configuration of a computer of an agent control device;

FIG. 4 is a diagram illustrating an example of identification information of plural agents;

FIG. 5 is a flowchart illustrating an example of processing performed by an agent control device according to an exemplary embodiment;

FIG. 6 is a diagram illustrating an example of a screen displayed on a touch panel;

FIG. 7 is a diagram illustrating an example of a screen displayed on a touch panel;

FIG. 8 is a diagram illustrating an example of a screen displayed on a touch panel;

and

FIG. 9 is a diagram illustrating an example of a screen displayed on a touch panel.

### DETAILED DESCRIPTION

### Exemplary Embodiment

Explanation follows regarding an agent control system of an exemplary embodiment, with reference to the drawings.

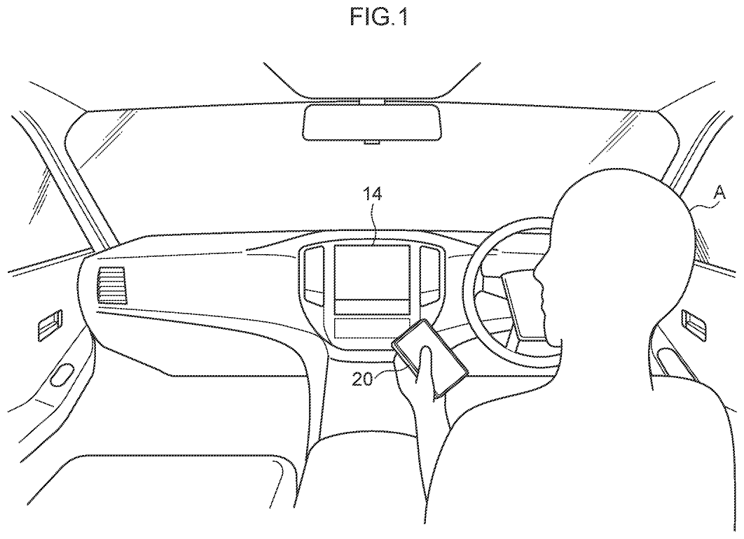

FIG. 1 is an explanatory diagram to provide schematic explanation of the present exemplary embodiment. FIG. 1 is a diagram illustrating a situation in which a user A is on board a vehicle. The user A possesses a mobile terminal 20 such as a smartphone. FIG. 1 also illustrates a touch panel 14, this being an example of a display device that displays various information, located inside the vehicle. The touch panel 14 and the mobile terminal 20 are connected to an agent control device, described later. The display device is not limited to a touch panel. The display device can be any presenter that can present or display various information.

In cases in which plural utilizable agents are available inside the vehicle, the user A may wish to operate an agent that they wish to utilize inside the vehicle.

An agent of the present exemplary embodiment performs speech interaction with the user A, and executes processing that reflects the content of this interaction. The agent then uses equipment inside the vehicle to output an execution result of this processing so as to reflect the interaction content. The agents of the present exemplary embodiment are implemented by agent servers, described later, executing predetermined programs.

For example, the user A may wish to utilize an agent that they regularly utilize on their mobile terminal 20 when inside the vehicle. The user A is able to utilize the agent that they regularly utilize on their mobile terminal 20 when inside the vehicle by establishing communication (pairing) the mobile terminal 20 with the agent control device. However, if the user A cancels such establishment of communication, or if establishment of communication times out, the user will be unable to smoothly select an agent if a decision on which agent to activate is not made.

Accordingly, the agent control device of the present exemplary embodiment presents a display screen showing procedure information to set up and establish communication between the mobile terminal 20 and the agent control device, and in cases in which information to reject establishment of communication between the mobile terminal 20 and the agent control device has been input, or in cases in which input of a procedure has not been received after a predetermined time period has elapsed since presentation of the display screen, a display screen recommending activation of a specific agent out of the plural utilizable agents available inside the vehicle is output. This enables the user A to select an agent smoothly by utilizing an agent selected by the agent control device in cases in which plural utilizable agents are available inside the vehicle.

Detailed explanation thereof follows below.

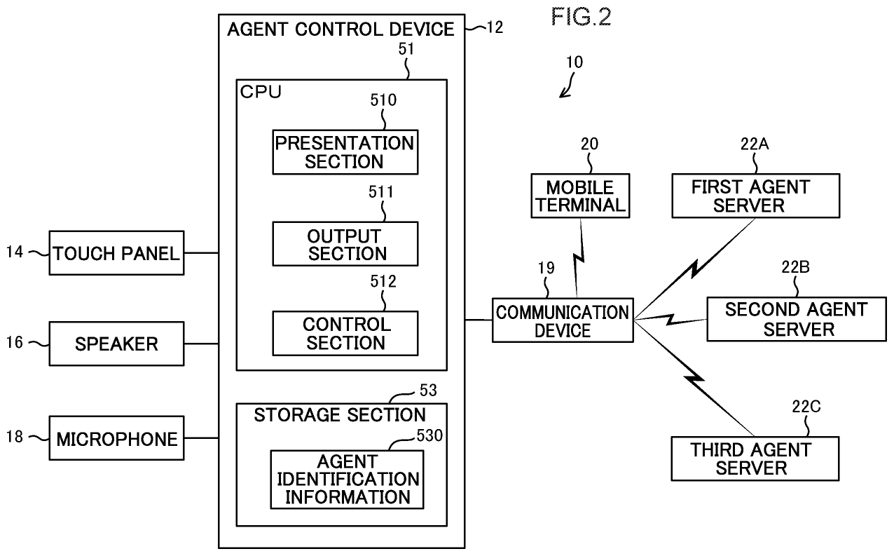

FIG. 2 is a block diagram illustrating an example of configuration of an agent control system 10 according to the exemplary embodiment. As illustrated in FIG. 2, the agent control system 10 includes an agent control device 12, the touch panel 14, a speaker 16, a microphone 18, a communication device 19, the mobile terminal 20, a first agent server 22A, a second agent server 22B, and a third agent server 22C. The agent control device 12, the touch panel 14, the speaker 16, the microphone 18, and the communication device 19 are all installed in a single vehicle.

Agent Control Device

As illustrated in FIG. 2, the agent control device 12 includes a central processing unit (CPU) 51 and a storage section 53.

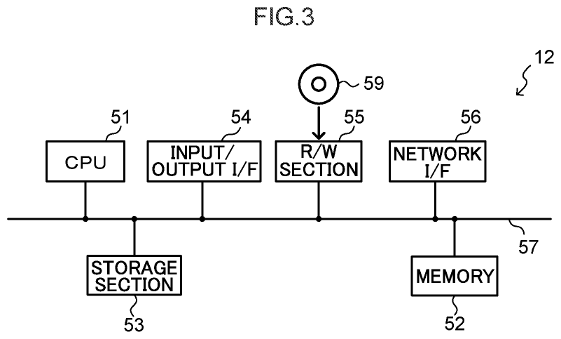

More specifically, the agent control device 12 may for example be implemented by a computer such as that illustrated in FIG. 3. The computer that implements the agent control device 12 includes the CPU 51, this being an example of a hardware processor, memory 52 serving as a temporary storage region, and the non-volatile storage section 53. The computer also includes an input/output interface (I/F) 54 to which an input/output device and so on are connected, and a read/write (R/W) section 55 that controls reading and writing of data on a recording medium 59. The computer also includes a network I/F 56 that is connected to a network such as the internet. The CPU 51, the memory 52, the storage section 53, the input/output I/F 54, the R/W section 55, and the network I/F 56 are connected to each other through a bus 57.

The storage section 53 may be implemented by a hard disk drive (HDD), a solid state drive (SSD), flash memory, or the like, these being examples of a non-transitory recording medium. The storage section 53 serves as a storage medium stored with a program causing the computer to implement functionality. The CPU 51 reads the program from the storage section 53, expands the program in the memory 52, and sequentially executes processes included in the program. The program may for example be recorded on a non-transitory recording medium such as a digital versatile disc (DVD), and read into the HDD, SSD, or the like from this non-transitory recording medium using a recording medium reader device.

As illustrated in FIG. 2, the CPU 51 of the agent control device 12 loads the program from the storage section 53 and executes the program using the memory 52 as a workspace in order to function as a presentation section 510, an output section 511, and a control section 512. Processing performed by the presentation section 510, the output section 511, and the control section 512 is described later.

As is also illustrated in FIG. 2, agent identification information 530 is stored in the storage section 53 of the agent control device 12.

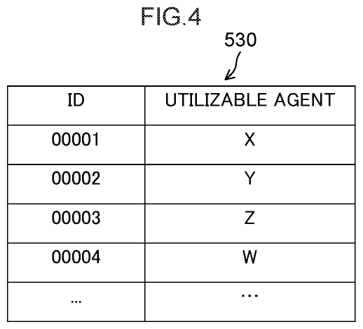

FIG. 4 is a diagram illustrating an example of the agent identification information 530 stored in the storage section 53. FIG. 4 illustrates an example of identification information for an agent X operated by the first agent server 22A, an agent Y operated by the second agent server 22B, an agent Z operated by the third agent server 22C, and an agent W operated by the mobile terminal 20. Note that the agent identification information 530 may be retained by the storage section 53 whenever agent activation processing, described later, is executed.

The touch panel 14 is connected to the agent control device 12 through the input/output I/F 54. The touch panel 14 displays images as appropriate. The touch panel 14 also receives operation information from a user.

The speaker 16 is connected to the agent control device 12 through the input/output I/F 54, and outputs audio.

The microphone 18 is connected to the agent control device 12 through the input/output I/F 54, and picks up speech uttered inside the vehicle.

The communication device 19 is an example of an onboard device. The communication device 19 is connected to the agent control device 12 through the network I/F 56. The agent control device 12 exchanges information with the first agent server 22A, the second agent server 22B, and the third agent server 22C via the communication device 19. Note that the communication device 19 and the first agent server 22A, the second agent server 22B, and the third agent server 22C may for example be connected together over a communication line such as the internet.

Similarly, the agent control device 12 and the mobile terminal 20 exchange information via the communication device 19. The agent control device 12 and the mobile terminal 20 are for example connected together using a predetermined short range communication protocol.

Agent Servers

As illustrated in FIG. 2, the agent control system 10 of the present exemplary embodiment includes the first agent server 22A, the second agent server 22B, and the third agent server 22C.

The first agent server 22A, the second agent server 22B, and the third agent server 22C are all servers that operate agents. The respective agents are implemented by the first agent server 22A, the second agent server 22B, and the third agent server 22C each executing a predetermined program. In the present exemplary embodiment, the agent X is operated by the first agent server 22A, the agent Y is operated by the second agent server 22B, and the agent Z is operated by the third agent server 22C.

Mobile Terminal

The mobile terminal 20 is for example a smartphone in the possession of and regularly used by a user inside the vehicle. The user on board the vehicle is able to utilize an agent operated by the mobile terminal 20. Note that the agent W is operated by the mobile terminal 20 in the present exemplary embodiment.

The mobile terminal 20 is capable of establishing communication with the communication device 19 using a short range wireless communication protocol such as Bluetooth (registered trademark). The mobile terminal 20 establishes communication with the communication device 19 so as to enable the user on board the vehicle to utilize the agent operated by the mobile terminal 20.

Next, explanation follows regarding operation of the agent control system 10 of the exemplary embodiment.

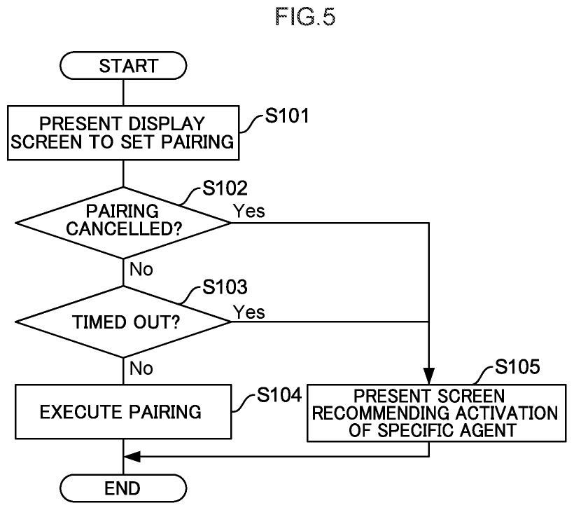

FIG. 5 is a flowchart illustrating an example of pairing processing performed by the agent control device 12. FIG. 5 illustrates an example of pairing processing by the agent control device 12 in a case in which the user A boards the vehicle and pairs the mobile terminal 20 and the communication device 19.

The presentation section 510 presents a display screen regarding pairing settings for the mobile terminal 20 and the communication device 19 on the touch panel 14 (step S101). Pairing setting of the communication device 19 and the mobile terminal 20 is a connection setting made to allow communication using a short range wireless communication protocol such as Bluetooth (registered trademark).

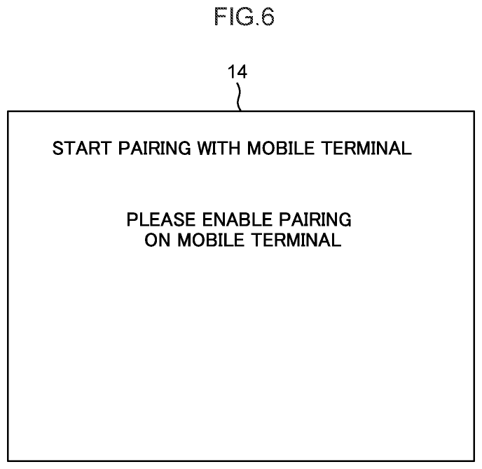

FIG. 6 illustrates an example of a display screen presented on the touch panel 14 by the presentation section 510. The example in FIG. 6 is a display screen presented on the touch panel 14 by the presentation section 510 at step S101. In the example in FIG. 6, a screen instructing the user A to perform a procedure on the mobile terminal 20 so as to enable pairing with the communication device 19 is presented on the touch panel 14.

Following step S101, the control section 512 determines whether or not the pairing processing of the mobile terminal 20 and the communication device 19 has been cancelled (step S102). Whether or not pairing has been cancelled may be determined based on whether or not input to cancel pairing has been made to the mobile terminal 20, or whether or not notification to cancel pairing has been transmitted to the communication device 19 from the mobile terminal 20.

If the determination result of step S102 is that the pairing processing of the mobile terminal 20 and the communication device 19 has not been cancelled (step S102: NO), the control section 512 then determines whether or not the pairing processing of the mobile terminal 20 and the communication device 19 has timed out (step S103).

If the determination result of step S103 is that the pairing processing of the mobile terminal 20 and the communication device 19 has not timed out (step S103: NO), the control section 512 then executes the pairing processing with the mobile terminal 20 (step S104). When the pairing processing with the mobile terminal 20 has been completed, the agent control device 12 becomes capable of executing commands directed to the agent W that is executed by the mobile terminal 20.

On the other hand, if the determination result of step S102 is that the pairing processing between the mobile terminal 20 and the communication device 19 has been cancelled (step S102: YES), or if the determination result of step S103 is that the pairing processing between the mobile terminal 20 and the communication device 19 has timed out (step S103: YES), the output section 511 presents a screen on the touch panel 14 to recommend activation of a specific agent (step S105). When the pairing processing is cancelled or the pairing processing times out, presenting a screen on the touch panel 14 to recommend activation of the specific agent enables the agent control device 12 to recommend activation of a desired specific agent to the user.

When the output section 511 presents the screen recommending activation of the specific agent on the touch panel 14, activation of a different agent to the agent operated by the mobile terminal 20 may be recommended. For example, in cases in which the agent operated by the mobile terminal 20 is the agent W, the output section 511 may present a screen recommending activation of the agent X, Y, or Z as the specific agent on the touch panel 14.

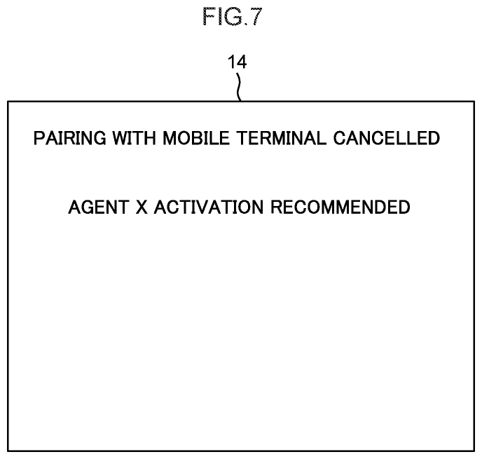

FIG. 7 illustrates an example of a display screen presented on the touch panel 14 by the output section 511. The example in FIG. 7 is a display screen presented on the touch panel 14 by the output section 511 at step S105. In the example in FIG. 7, since the pairing processing between the mobile terminal 20 and the communication device 19 has been cancelled, a screen recommending activation of the agent X as the specific agent is presented on the touch panel 14.

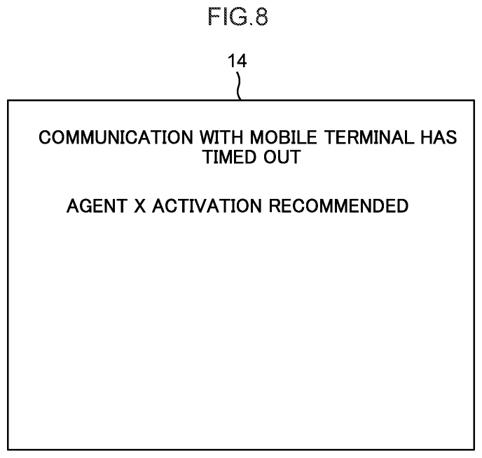

FIG. 8 illustrates an example of a display screen presented on the touch panel 14 by the output section 511. The example in FIG. 8 is a display screen presented on the touch panel 14 by the output section 511 at step S105. In the example in FIG. 8, since the pairing processing between the mobile terminal 20 and the communication device 19 has timed out, a screen recommending activation of the agent X as the specific agent is presented on the touch panel 14.

Information indicating that this specific agent will also be operated on subsequent occasions going forward may also be output when the output section 511 presents a screen recommending activation of a specific agent on the touch panel 14 at step S105.

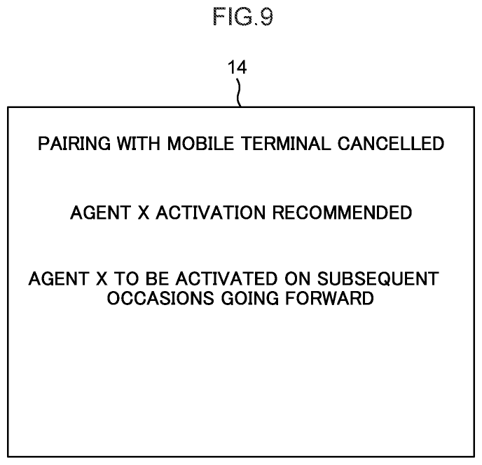

FIG. 9 illustrates an example of a display screen presented on the touch panel 14 by the output section 511. The example in FIG. 9 is a display screen presented on the touch panel 14 by the output section 511 at step S105. In the example in FIG. 9, since the pairing processing between the mobile terminal 20 and the communication device 19 has been cancelled, a screen recommending activation of the agent X as the specific agent and explaining that the agent X will be also activated on subsequent occasions going forward is presented on the touch panel 14.

The agent control device 12 of the exemplary embodiment described above is capable of guiding toward activation of a specific agent in cases in which pairing processing between the mobile terminal 20 and the communication device 19 has been cancelled or in cases in which pairing processing between the mobile terminal 20 and the communication device 19 has timed out.

Although explanation has been given in which the processing performed by the respective devices is software processing performed by executing a program in the exemplary embodiment described above, the processing may be performed by hardware. Alternatively, the processing may be performed by a combination of both software and hardware. Moreover, a program stored in ROM may be distributed in a format stored on a non-transitory recording medium.

The present disclosure is not limited to the above description, and various other modifications may be implemented within a range not departing from the spirit of the present disclosure.

For example, configuration may be made such that the display screen presented by the presentation section 510 at step S101 is not presented on subsequent occasions going forward of cases in which the pairing processing between the mobile terminal 20 and the communication device 19 has been cancelled or in cases in which the pairing processing between the mobile terminal 20 and the communication device 19 has timed out. The control section 512 may simply perform control to activate a specific agent.

An object of the present disclosure is to provide an agent control device, an agent control method, and a non-transitory recording medium capable of improving selection from out of plural agents.

A first aspect of the disclosure is an agent control device that includes: a memory; and a processor coupled to the memory. The processor is configured to present, on a display device, a display screen showing procedure information to set up and establish communication between a mobile terminal and an onboard device, and in a case in which information to reject establishment of communication between the mobile terminal and the onboard device has been input, or in a case in which input of a procedure has not been received after a predetermined time period has elapsed since presentation of the display screen on the display device, output to the display device a display screen recommending activation of a specific agent from among a plurality of agents that are utilizable inside a vehicle.

The agent control device presents on the display device the display screen showing procedure information to set up and establish communication between the mobile terminal and the onboard device. In a case in which information to reject establishment of communication between the mobile terminal and the onboard device has been input, or in a case in which input of the procedure has not been received after a predetermined time period has elapsed since presentation of the display screen on the display device, the agent control device outputs to the display device the display screen recommending activation of the specific agent from among the plural agents that are utilizable inside the vehicle. Note that the agent of the present aspect performs speech interaction with the user, and executes processing that reflects the content of this interaction. The agent then uses equipment inside the vehicle to output an execution result of this processing so as to reflect the interaction content. The agent is implemented by a predetermined computer executing a program. The agent control device of the first aspect is capable of recommending activation of the specific agent from out of the plural utilizable agents available inside the vehicle in cases in which communication between the mobile terminal and the onboard device cannot be established.

A second aspect of the disclosure is the agent control device of the first aspect, wherein the processor is configured to output, to the display device, a display screen recommending activation, as the specific agent, of a different agent from an agent operated by the mobile terminal. The agent control device of the second aspect is capable of recommending activation an agent that is different to the agent operated by the mobile terminal in cases in which communication between the mobile terminal and the onboard device cannot be established.

A third aspect of the disclosure is the agent control device of the first aspect, wherein in a case in which information to reject the establishment of communication has been input, or in a case in which input of a procedure has not been received after a predetermined time period has elapsed since presentation of the display screen on the display device, the processor is configured to output, to the display device, a display screen recommending activation of a specific agent from among the plurality of agents, and also output, to the display device, information indicating that the specific agent will be operated from a subsequent occasion going forward. The agent control device of the third aspect is capable of recommending activation of the specific agent and operating the specific agent from the subsequent occasion going forward in cases in which communication between the mobile terminal and the onboard device cannot be established.

A fourth aspect of the disclosure is the agent control device of the first aspect, wherein, in a case in which information to reject the establishment of communication has been input, or in a case in which input of a procedure has not been received after a predetermined time period has elapsed since presentation of the display screen on the display device, the processor is configured not to present, on the display device, a display screen showing procedure information to set up and establish the communication from a subsequent occasion going forward. The agent control device of the fourth aspect is capable of skipping presentation of the screen to set up and establish communication in cases in which communication between the mobile terminal and the onboard device cannot be established.

The first to fourth aspects may also be implemented by a method or by a program recorded on a non-transitory recording medium.

The present disclosure is capable of providing an agent control device, an agent control method, and a non-transitory recording medium capable of improving selection from out of plural agents by recommending activation of a specific agent from out of plural utilizable agents available inside a vehicle in cases in which communication between a mobile terminal and an onboard device cannot be established.

What is claimed is:

1. An agent control device comprising:
a memory; and
a processor coupled to the memory, the processor being configured to:
present, on a display device, a display screen showing procedure information to set up and establish communication between a mobile terminal and an onboard device, and
in a case in which information to reject establishment of communication between the mobile terminal and the onboard device has been input, or in a case in which input of a procedure has not been received after a predetermined time period has elapsed since presentation of the display screen on the display device, output to the display device a display screen recommending activation of a specific agent from among a plurality of agents that are utilizable inside a vehicle.

2. The agent control device of claim 1, wherein the processor is configured to output, to the display device, a display screen recommending activation, as the specific agent, of a different agent from an agent operated by the mobile terminal.

3. The agent control device of claim 1, wherein in a case in which information to reject the establishment of communication has been input, or in a case in which input of a procedure has not been received after a predetermined time period has elapsed since presentation of the display screen on the display device, the processor is configured to output, to the display device, a display screen recommending activation of a specific agent from among the plurality of agents, and also output, to the display device, information indicating that the specific agent will be operated from a subsequent occasion going forward.

4. The agent control device of claim 1, wherein, in a case in which information to reject the establishment of communication has been input, or in a case in which input of a procedure has not been received after a predetermined time period has elapsed since presentation of the display screen on the display device, the processor is configured not to present, on the display device, a display screen showing procedure information to set up and establish the communication from a subsequent occasion going forward.

5. An agent control method, comprising:
by a processor,
presenting on a display device, a display screen showing procedure information to set up and establish communication between a mobile terminal and an onboard device; and
in a case in which information to reject establishment of communication between the mobile terminal and the onboard device has been input, or in a case in which input of a procedure has not been received after a predetermined time period has elapsed since presentation of the display screen on the display device, outputting, to the display device, a display screen recommending activation of a specific agent from among a plurality of agents that are utilizable inside a vehicle.

6. The agent control method of claim 5, wherein a display screen recommending activation, as the specific agent, of a different agent from an agent operated by the mobile terminal is output to the display device.

7. The agent control method of claim 5, wherein, in a case in which information to reject the establishment of communication has been input, or in a case in which input of a procedure has not been received after a predetermined time period has elapsed since presentation of the display screen on the display device, a display screen recommending activation of a specific agent from among the plurality of agents is output to the display device, and information indicating that the specific agent will be operated from a subsequent occasion going forward is also output to the display device.

8. The agent control method of claim 5, wherein in a case in which information to reject the establishment of communication has been input, or in a case in which input of a procedure has not been received after a predetermined time period has elapsed since presentation of the display screen on the display device, a display screen showing procedure information to set up and establish the communication is not presented on the display device from a subsequent occasion going forward.

9. A non-transitory recording medium storing a program that is executable by a computer to perform processing, the processing comprising:
presenting, on a display device, a display screen showing procedure information to set up and establish communication between a mobile terminal and an onboard device; and
in a case in which information to reject establishment of communication between the mobile terminal and the onboard device has been input, or in a case in which input of a procedure has not been received after a predetermined time period has elapsed since presentation of the display screen on the display device, outputting, to the display device, a display screen recommending activation of a specific agent from among a plurality of agents that are utilizable inside a vehicle.

10. The non-transitory recording medium of claim 9, wherein a display screen recommending activation, as the specific agent, of a different agent from an agent operated by the mobile terminal is output to the display device.

11. The non-transitory recording medium of claim 9 wherein, in a case in which information to reject the establishment of communication has been input, or in a case in which input of a procedure has not been received after a predetermined time period has elapsed since presentation of the display screen on the display device, a display screen recommending activation of a specific agent from among the plurality of agents is output to the display device, and information indicating that the specific agent will be operated from a subsequent occasion going forward is also output to the display device.

12. The non-transitory recording medium of claim 9, wherein, in a case in which information to reject the establishment of communication has been input, or in a case in which input of a procedure has not been received after a predetermined time period has elapsed since presentation of the display screen on the display device, a display screen showing procedure information to set up and establish the communication is not presented on the display device from a subsequent occasion going forward.
